(19) United States
(12) Patent Application Publication
(10) Pub. No.: US 2026/0068012 A1
(43) Pub. Date: Mar. 5, 2026

(54) SOLAR STEPLESS DIMMING LAMP

(71) Applicant: JIAWEI RENEWABLE ENERGY CO., LTD., Shenzhen City (CN)

(72) Inventor: Guoqiang CHEN, Shenzhen City (CN)

(21) Appl. No.: 18/891,567

(22) Filed: Sep. 20, 2024

(30) Foreign Application Priority Data
Sep. 4, 2024 (CN) 202422168761.X

(51) Int. Cl. H05B 47/11; H02J 7/35; H05B 45/10

(52) U.S. Cl. CPC H05B 47/11; H02J 7/35; H05B 45/10

(57) ABSTRACT

Provided is a solar stepless dimming lamp which includes a solar panel, a light-emitting body controller, a stepless dimming control switch, a battery and a light-emitting body. The solar panel is connected to the battery, the battery is connected to the light-emitting body, the light-emitting body is connected to the light-emitting body controller, and the light-emitting body controller is connected to the stepless dimming control switch. The solar panel is configured to provide electrical energy to the battery. The battery is configured to store the electrical energy and provide the electrical energy to the light-emitting body. The stepless dimming control switch is configured to obtain control information input by a user and send the control information to the light-emitting body controller. The light-emitting body controller is configured to control the light-emitting body according to the control information.

### CROSS-REFERENCE TO RELATED APPLICATION

Pursuant to 35 U.S.C. § 119 and the Paris Convention, this application claims the benefit of Chinese Patent Application No. 202422168761.X filed on Sep. 4, 2024, the content of which is incorporated herein by reference.

### TECHNICAL FIELD

The present application relates to the field of lamp technology, more particularly to a solar stepless dimming lamp.

### BACKGROUND

The statements provided herein are merely background information related to the present application, and do not necessarily constitute any prior arts. A solar lamp is a device that converts solar energy into electrical energy and utilizes the electrical energy to make a light-emitting body emit light to provide a light source. In actual use of solar lamps, users usually need to adjust the brightness of the solar lamps.

In existing solar lamps, a limited number of brightness levels are usually set so that the users can adjust the brightness of the solar lamps by selecting a brightness level. Since the brightness levels of existing solar lamps are limited and cannot fully meet users'requirements for the brightness of solar lamps, the practicality of existing solar lamps is low.

### SUMMARY

In view of this, a solar stepless dimming lamp is provided in embodiments of the present application to solve the technical problem of low practicality of existing solar lamps.

In a first aspect, an embodiment of the present application provides a solar stepless dimming lamp, which includes a solar panel, a light-emitting body controller, a stepless dimming control switch, a battery and a light-emitting body. The solar panel is connected to the battery, the battery is connected to the light-emitting body, the light-emitting body is connected to the light-emitting body controller, and the light-emitting body controller is connected to the stepless dimming control switch.

The solar panel is configured to provide electric energy to the battery. The battery is configured to store the electric energy and provide the electric energy to the light-emitting body. The stepless dimming control switch is configured to obtain control information input by a user and send the control information to the light-emitting body controller. The light-emitting body controller is configured to control the light-emitting body according to the control information.

Optionally, the light-emitting body controller includes a first controller and a second controller. The first controller is connected to the stepless dimming control switch and the second controller, and the second controller is connected to the light-emitting body.

The first controller is configured to receive the control information, generate a control parameter according to the control information, and send the control parameter to the second controller.

The second controller is configured to control the light-emitting body according to the control parameter.

Optionally, the light-emitting body controller also includes a first photoresistor. The first photoresistor is connected to the first controller.

The first controller is also configured to generate a switch signal according to a resistance value of the first photoresistor, and send the switch signal to the second controller.

The second controller is also configured to control the light-emitting body according to the switch signal.

Optionally, the first controller includes a timer that is configured to record a duration when the stepless dimming control switch is in a closed state. The first controller is configured to generate the control parameter according to the duration when the stepless dimming control switch is in the closed state.

Optionally, the first controller also includes a memory connected to the timer, and the memory is configured to receive and store the control parameter generated by the first controller.

Optionally, the solar stepless dimming lamp also includes a charge-and-discharge management unit. The charge-and-discharge management unit is connected between the solar panel and the battery.

Optionally, the charge-and-discharge management unit includes a second photoresistor, a first resistor, a second resistor, a third resistor, a charge-and-discharge controller, a diode and a capacitor.

A first end of the first resistor, an anode of the solar panel and an anode of the diode are connected in common. A second end of the first resistor, an output end of the second photoresistor and a first end of the second resistor are connected in common. A second end of the second resistor, a cathode of the solar panel, a normally-closed pin of the charge-and-discharge controller and a voltage input pin of the charge-and-discharge controller are grounded. A cathode of the diode, a first end of the third resistor and an anode of the battery are connected in common. A second end of the third resistor, a voltage output pin of the charge-and-discharge controller and a first end of the capacitor are connected in common. A ground pin of the charge-and-discharge controller, a voltage information receiving pin of the charge-and-discharge controller, a second end of the capacitor and a cathode of the battery are connected in common.

Optionally, the stepless dimming control switch is a touch switch.

Optionally, the light-emitting body includes at least one light-emitting diode.

Optionally, an anode of the light-emitting body is connected to an anode of the battery, and a cathode of the light-emitting body is connected to a control end of the second controller.

The implementation of the solar stepless dimming lamp provided by the embodiment of the present application has at least the following beneficial effects:

The solar stepless dimming lamp provided by the embodiment of the present application includes a solar panel, a light-emitting body controller, a stepless dimming control switch, a battery and a light-emitting body. The solar panel is connected to the battery, the battery is connected to the light-emitting body, the light-emitting body is connected to the light-emitting body controller, and the light-emitting body controller is connected to the stepless dimming control switch. The solar panel is configured to provide electrical energy to the battery. The battery is configured to store the electrical energy and provide the electrical energy to the light-emitting body. The stepless dimming control switch is configured to obtain control information input by a user and send the control information to the light-emitting body controller. The light-emitting body controller is configured to control the light-emitting body according to the control information. In the embodiments of the present application, the solar stepless dimming lamp provided is provided with a stepless dimming control switch, and the user can adjust the brightness of the solar stepless dimming lamp at will through the stepless dimming control switch, thereby the practicality of the solar lamp is improved.

### BRIEF DESCRIPTION OF DRAWINGS

In order to illustrate the technical solutions in the embodiments of the present application more clearly, the drawings that need to be used in the description of the embodiments will be briefly introduced below. Obviously, the drawings in the following description are merely some embodiments of the present application. For persons of ordinary skill in the art, other drawings may also be obtained based on these drawings without exerting creative efforts.

FIG. 1 is a schematic structural diagram of a solar stepless dimming lamp provided in an embodiment of the present application;

FIG. 2 is a schematic structural diagram of a solar stepless dimming lamp provided in another embodiment of the present application; and

FIG. 3 is a schematic structural diagram of a solar stepless dimming lamp provided in another embodiment of the present application.

### DETAILED DESCRIPTION OF EMBODIMENTS

It should be noted that the terms used in the embodiments of the present application are only used to explain the specific embodiments of the present application, and are not intended to limit the present application. In the description of the embodiments of the present application, unless otherwise specified, the phrase “a/the plurality of” means two or more than two, and the phrases “at least one” and “one or more” mean one, two or more than two. The terms “first” and “second” are used for descriptive purposes only and cannot be understood as indicating or implying relative importance or implicitly indicating the number of technical features indicated. Therefore, the feature defined with the wording “first” or “second” may explicitly or implicitly include one or more of such features.

The reference to “one embodiment” or “some embodiments” described in this specification means that the specific features, structures or characteristics described in combination with the embodiment may be included in one or more embodiments of the present application. Thus, the phrases “in one embodiment,” “in some embodiments,” “in some other embodiments,” “in yet other embodiments,” etc., appearing in various places in this specification do not necessarily all refer to the same embodiment, but rather mean “one or more but not all embodiments,” unless specifically emphasized otherwise. The terms “include”, “comprising”, “having” and variations thereof mean “including but not limited to”, unless specifically emphasized otherwise.

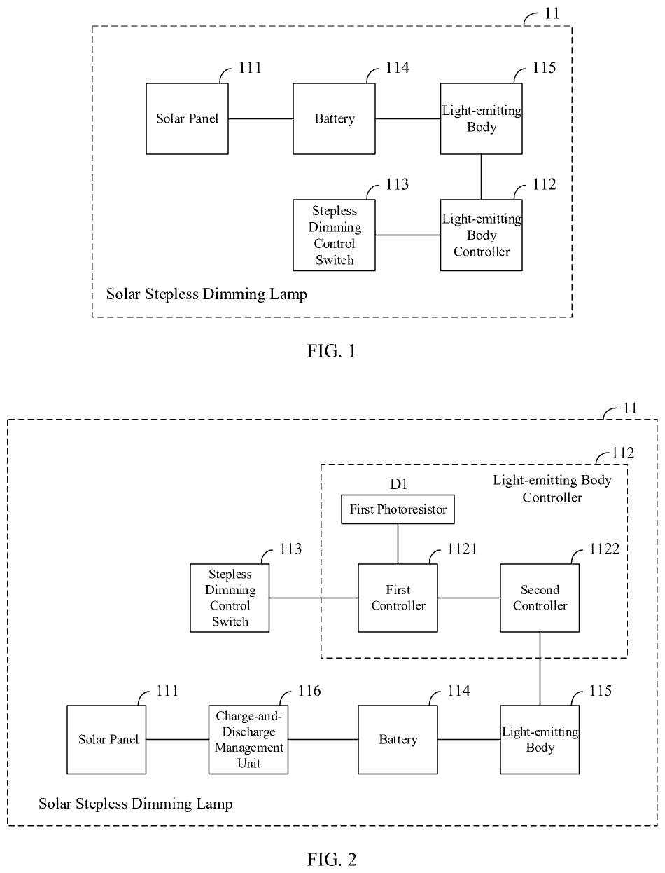

The embodiment of the present application first provides a solar stepless dimming lamp, referring to FIG. 1, FIG. 1 is a schematic structural diagram of a solar stepless dimming lamp provided in an embodiment of the present application. As shown in FIG. 1, the solar stepless dimming lamp 11 may include a solar panel 111, a light-emitting body controller 112, a stepless dimming control switch 113, a battery 114 and a light-emitting body 115.

Herein, the solar panel 111 is connected to the battery 114, the battery 114 is connected to the light-emitting body 115, the light-emitting body 115 is connected to the light-emitting body controller 112, and the light-emitting body controller 112 is connected to the stepless dimming control switch 113.

The solar panel 111 may be configured to provide electric energy to the battery 114. Particularly, the solar panel 111 is configured to convert solar energy into electrical energy and transmit the electrical energy to the battery 114 for storage.

The battery 114 may be configured to receive the electrical energy transmitted by the solar panel 111, and may be configured to store the electrical energy, and also may provide the electrical energy for the light-emitting body 115.

The stepless dimming control switch 113 may be configured to obtain control information input by a user and send the control information to the light-emitting body controller 112. Exemplarily, the user may input the control information to the stepless dimming control switch 113 by long pressing, short pressing, or clicking the stepless dimming control switch 113 several times.

In the embodiment of the present application, the stepless dimming control switch 113 may be a touch switch, and the number of the stepless dimming control switches 113 may be 1.

The light-emitting body 115 may be configured to emit light as a light source. In the embodiment of the present application, the light-emitting body 115 may be composed of a plurality of light-emitting diodes.

The light-emitting body controller 112 may be configured to receive control information sent by the stepless dimming control switch 113, and control the light-emitting body 115 according to the control information. Particularly, the light-emitting body controller 112 may generate a control parameter according to the control information, and control the light-emitting body 115 according to the control parameter.

Herein, the control information may include a duration when the stepless dimming control switch 113 is in a closed state, and the control parameter may include a brightness control parameter. Based on this, the light-emitting body controller 112 may generate the brightness control parameter according to the duration when the stepless dimming control switch 113 is in the closed state included in the control information, and control the light-emitting body 115 according to the brightness control parameter.

The user may control the brightness of the light-emitting body 115 by controlling a duration of touching the stepless dimming control switch 113. Exemplarily, the user may control the brightness of the light-emitting body 115 to increase from the current brightness value to the maximum value or decrease from the current brightness value to the minimum value by long pressing the stepless dimming control switch 113, and may stop touching when the brightness of the light-emitting body 115 reaches the user's expected brightness.

Herein, the control parameter may include a switch control parameter for controlling the light-emitting body 115 to switch on or off. Based on this, the light-emitting body controller 112 may generate the switch control parameter according to the duration when the stepless dimming control switch 113 is in the closed state included in the control information, and control the light-emitting body 115 according to the switch control parameter.

The user may control the light-emitting body 115 to switch on or off by controlling the duration of touching the stepless dimming control switch 113. Exemplarily, the user may control the light-emitting body 115 to switch off by clicking when the light-emitting body 115 is switched on, and the user may control the light-emitting body 115 to switch on by clicking when the light-emitting body 115 is switched off.

Since the solar stepless dimming lamp 11 provided in the present application includes the stepless dimming control switch 113 and the light-emitting body controller 112, the transition in brightness of the solar stepless dimming lamp 11 is smooth, thus, the user can arbitrarily set the brightness of the solar stepless dimming lamp according to actual needs.

It can be seen from the above that the solar stepless dimming lamp provided in the embodiment of the present application includes a solar panel, a light-emitting body controller, a stepless dimming control switch, a battery and a light-emitting body. The solar panel is connected to the battery, the battery is connected to the light-emitting body, the light-emitting body is connected to the light-emitting body controller, and the light-emitting body controller is connected to the stepless dimming control switch. The solar panel is configured to provide electric energy to the battery. The battery is configured to store the electric energy and provide the electric energy to the light-emitting body. The stepless dimming control switch is configured to obtain control information input by the user and send the control information to the light-emitting body controller. The light-emitting body controller is configured to control the light-emitting body according to the control information. The solar stepless dimming lamp provided in the embodiment of the present application is provided with a stepless dimming control switch, and the user can adjust the brightness of the solar stepless dimming lamp at will through the stepless dimming control switch, thereby the practicality of the solar lamp is improved.

Referring to FIG. 2, which is a schematic structural diagram of a solar stepless dimming lamp provided in another embodiment of the present application. As shown in FIG. 2, in a possible implementation, the light-emitting body controller 112 in the solar stepless dimming lamp 11 may include a first controller 1121 and a second controller 1122.

Herein, the first controller 1121 may be connected to the stepless dimming control switch 113 and the second controller 1122, and the second controller 1122 may be connected to the light-emitting body 115.

In the embodiment of the present application, the first controller 1121 may be configured to receive control information, generate a control parameter according to the control information, and send the control parameter to the second controller 1122.

Particularly, the first controller 1121 may generate a brightness control parameter according to the duration when the stepless dimming control switch 113 is in a closed state included in the control information, and may generate a switch control parameter according to the duration when the stepless dimming control switch 113 is in the closed state included in the control information, and then the first controller 1121 may send the generated brightness control parameter or switch control parameter to the second controller 1122.

The second controller 1122 may be configured to receive the control parameter and control the light-emitting body 115 according to the control parameter.

In a possible implementation, the light-emitting body controller 112 may also include a first photoresistor D1. Herein, the first photoresistor D1 may be connected to the first controller 1121.

The first controller 1121 may be configured to generate the switch control parameter according to a resistance value of a first photoresistor D1, and send the switch control parameter to the second controller 1122.

Exemplarily, the first controller 1121 may be configured to determine whether the light in the external environment is sufficient according to the resistance value of the first photoresistor D1. If it is determined that the light in the external environment is insufficient (such as at night), then the switch control parameter may be generated to automatically control the light source 115 to switch on.

In a possible implementation, the first controller 1121 may include a timer. The timer may be configured to record a duration when the stepless dimming control switch 113 is in a closed state, and the first controller 1121 may be configured to generate a control parameter according to the duration when the stepless dimming control switch 113 is in the closed state.

In a possible implementation, the first controller 1121 may include a memory. The memory is connected to the timer. The memory may be configured to receive and store the control parameter generated by the first controller 1121. Based on this, after the control parameter generated by the first controller 1121, the control parameter may be stored in the memory, even after the solar stepless dimming lamp 11 is powered off, the control parameter generated by the first controller 1121 will also be stored in the memory. Therefore, after a recharging of the solar stepless dimming lamp 11 is completed, the first controller 1121 can obtain again an original control parameter and control the light-emitting body 115 through the original control parameter, so that the light-emitting body 115 will emit light at the brightness before the power failure.

Based on this, after the brightness of the light-emitting body 115 is set by the user, the first controller 1121 may store the duration when the stepless dimming control switch 113 is in the closed state through the memory. When the light-emitting body 115 needs to be controlled to switch on next time, the brightness of the light-emitting body 115 may be controlled by the first controller 1121 according to the duration when the stepless dimming control switch 113 is in the closed state stored in the memory. Thus, the solar stepless dimming lamp 11 has a brightness memory function.

In a possible implementation, the solar stepless dimming lamp 11 may also include a charge-and-discharge management unit 116.

The charge-and-discharge management unit 116 may be connected between the solar panel 111 and the battery 114.

The charge-and-discharge management unit 116 may be configured to manage a charge-and-discharge process of the battery 114. Particularly, the charge-and-discharge management unit 116 may be configured to perform overcharge protection and over-discharge protection on the charge-and-discharge process of the battery 114.

In a possible implementation, an anode of the light-emitting body 115 is connected to an anode of the battery 114, and a cathode of the light-emitting body 114 is connected to a control end of the second controller 1122.

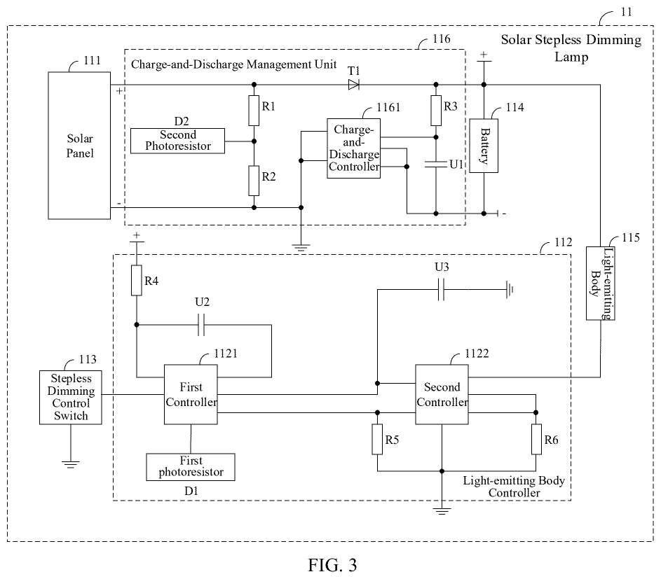

Referring to FIG. 3, which is a schematic structural diagram of a solar stepless dimming lamp provided by another embodiment of the present application. As shown in FIG. 3, in a possible implementation, the charge-and-discharge management unit 116 may include a second photoresistor D2, a first resistor R1, a second resistor R2, a third resistor R3, a charge-and-discharge controller 1161, a diode T1 and a first capacitor U1.

Herein, a first end of the first resistor R1, an anode of the solar panel 111 and an anode of the diode T1 are connected in common. A second end of the first resistor R1, a first end of the second photoresistor D1 and a first end of the second resistor R2 are connected in common. A second end of the second resistor R2, a cathode of the solar panel 111, a normally-closed pin of the charge-and-discharge controller 1161 and a voltage input pin of the charge-and-discharge controller 1161 are grounded. A cathode of the diode T1, a first end of the third resistor R3 and an anode of the battery 114 are connected in common. A second end of the third resistor R3, a voltage output pin of the charge-and-discharge controller 1161 and a first end of the first capacitor U1 are connected in common. A ground pin of the charge-and-discharge controller 1161, a voltage information receiving pin of the charge-and-discharge controller 1161, a second end of the first capacitor U1 and a cathode of the battery 114 are connected in common.

In a possible implementation, the cathode of the diode T1, the first end of the third resistor R3 and the anode of the battery 114 are also connected in common to the anodes of each light-emitting diode in the light-emitting body 115.

In a possible implementation, the charge-and-discharge management unit 116 may also include a power supply. Herein, an anode of the power supply is connected to the cathode of the diode T1, the first end of the third resistor R3 and the anode of the battery 114. A cathode of the power supply may be connected to the ground pin of the charge-and-discharge controller 1161, the voltage information receiving pin of the charge-and-discharge controller 1161, the second end of the first capacitor U1 and the cathode of the battery 114.

In a possible implementation, the light-emitting body controller 112 may include a first controller 1121, a second controller 1122, a first photoresistor D1, a fourth resistor R4, a fifth resistor R5, a sixth resistor R6, a second capacitor U2 and a third capacitor U3.

Herein, a control information input pin of the first controller 1121 is connected to a first end of the stepless dimming control switch 113. A first end of the fourth resistor R4, a first end of the second capacitor U2 and a first power supply pin of the first controller 1121 are connected in common. A second end of the second capacitor U2 is connected to a second power supply pin of the first controller 1121. A photoresistor input pin of the first controller 1121 is connected to the first photoresistor D1. A control parameter output pin of the first controller 1121 is connected in common to a control parameter input pin of the second controller 1122 and a first end of the fifth resistor R5. A power output pin of the first controller 1121 is connected in common to a first end of the third capacitor U3 and a power input pin of the second controller 1122. A second end of the third capacitor U3 is grounded. A second end of the fifth resistor R5, a ground pin of the second controller 1122 and a first end of the sixth resistor R6 are connected in common to a ground line A second end of the sixth resistor R6, a first chip select pin of the second controller 1122 and a second chip select pin of the second controller 1122 are connected in common. A control pin of the second controller 1122 is connected to the cathode of each light-emitting diode of the light-emitting body 115, and a second end of the fourth resistor R4 is connected to the anode of the power supply.

In a possible implementation, a second end of the stepless dimming control switch 113 is grounded.

The working mode of the solar stepless dimming lamp provided in the embodiment of the present application is described below in conjunction with FIG. 3.

The first controller 1121 may obtain the resistance value of the first photoresistor D1 through the photoresistor input pin of the first controller 1121, and then may generate a switch control parameter based on the resistance value of the first photoresistor D1 and send the switch control parameter to the second controller 1122 through the control parameter output pin of the first controller 1121, to enable the second controller 1122 to control the light-emitting body 115 to switch on or off. Exemplarily, it may be determined by the first controller 1121 that the light is insufficient through the resistance value of the first photoresistor D1, and then the switch control parameter for controlling the light-emitting body 115 to switch on is generated by the first controller 1121. It may be determined by the first controller 1121 that the light is sufficient through the resistance value of the first photoresistor D1, and then the switch control parameter for controlling the light-emitting body 115 to switch off is generated by the first controller 1121.

The first controller 1121 may also obtain the control information sent by the stepless dimming control switch 113 through the control information input pin of the first controller 1121, and then may generate a control parameter based on the control information and send the control parameter to the control parameter input pin of the second controller 1122 through the control parameter output pin of the first controller 1121, so that the control parameter is received by the second controller 1122, and then the second controller 1122 is enabled to control the light-emitting body 115 through the control pin of the second controller 1122 according to the received control parameter.

In the above embodiments, the description of each embodiment has its own emphasis. For the part that is not described or recorded in a certain embodiment, references may be made to the relevant description of other embodiments.

It would be appreciated by persons of ordinary skill in the art that the units and algorithm steps of each example described in combination with the embodiments disclosed in this article can be implemented by electronic hardware, or a combination of computer software and electronic hardware. Whether these functions are executed in hardware or software depends on the specific application and design constraints of the technical solution. Professional and technical personnel may use different methods to implement the described functions for each specific application, but such implementation should not be considered to exceed the scope of the present application.

The embodiments described above are used only to illustrate, rather than limiting, the technical solutions of the present application. Although the present application has been described in detail with reference to the aforementioned embodiments, it should be understood for persons skilled in the art that the technical solutions described in the aforementioned embodiments may still be modified, or some of the technical features may be replaced by equivalents. Such modifications or replacements do not deviate the essence of the corresponding technical solutions from the spirit and scope of the technical solutions of various embodiments of the present application, and thus should all be included within the protection scope of the present application.

What is claimed is:

1. A solar stepless dimming lamp, comprising
a solar panel;
a battery, connected to the solar panel
a light-emitting body, connected to the battery;
a light-emitting body controller, connected to the light-emitting body; and
a stepless dimming control switch, connected to the light-emitting body controller,
wherein the solar panel is configured to provide electric energy to the battery; the battery is configured to store the electric energy and provide the electric energy to the light-emitting body; the stepless dimming control switch is configured to obtain control information input by a user and send the control information to the light-emitting body controller; and the light-emitting body controller is configured to control the light-emitting body according to the control information.

2. The solar stepless dimming lamp according to claim 1, wherein the light-emitting body controller comprises a first controller and a second controller; the first controller is connected to the stepless dimming control switch and the second controller, and the second controller is connected to the light-emitting body;
the first controller is configured to receive the control information, generate a control parameter according to the control information, and send the control parameter to the second controller; and
the second controller is configured to control the light-emitting body according to the control parameter.

3. The solar stepless dimming lamp according to claim 2, wherein the light-emitting body controller further comprises a first photoresistor, and the first photoresistor is connected to the first controller;
the first controller is further configured to generate a switch signal according to a resistance value of the first photoresistor, and send the switch signal to the second controller; and
the second controller is further configured to control the light-emitting body according to the switch signal.

4. The solar stepless dimming lamp according to claim 2, wherein the first controller comprises a timer, and the timer is configured to record a duration when the stepless dimming control switch is in a closed state, and the first controller is configured to generate the control parameter according to the duration when the stepless dimming control switch is in the closed state.

5. The solar stepless dimming lamp according to claim 4, wherein the first controller further comprises a memory, and the memory is connected to the timer, and the memory is configured to receive and store the control parameter generated by the first controller.

6. The solar stepless dimming lamp according to claim 1, wherein the solar stepless dimming lamp further comprises a charge-and-discharge management unit, and the charge-and-discharge management unit is connected between the solar panel and the battery.

7. The solar stepless dimming lamp according to claim 6 is wherein the charge-and-discharge management unit comprises a second photoresistor, a first resistor, a second resistor, a third resistor, a charge-and-discharge controller, a diode and a capacitor;
a first end of the first resistor, an anode of the solar panel and an anode of the diode are connected in common,
a second end of the first resistor, an output end of the second photoresistor and a first end of the second resistor are connected in common,
a second end of the second resistor, a cathode of the solar panel, a normally-closed pin of the charge-and-discharge controller and a voltage input pin of the charge-and-discharge controller are grounded,
a cathode of the diode, a first end of the third resistor and an anode of the battery are connected in common,
a second end of the third resistor, a voltage output pin of the charge-and-discharge controller and a first end of the capacitor are connected in common, and
a ground pin of the charge-and-discharge controller, a voltage information receiving pin of the charge-and-discharge controller, a second end of the capacitor and a cathode of the battery are connected in common.

8. The solar stepless dimming lamp according to claim 1 is wherein the stepless dimming control switch is a touch switch.

9. The solar stepless dimming lamp according to claim 1 is wherein the light-emitting body comprises at least one light-emitting diode.

10. The solar stepless dimming lamp according to claim 2, wherein an anode of the light-emitting body is connected to an anode of the battery, and a cathode of the light-emitting body is connected to a control end of the second controller.
